(19) United States
(12) Patent Application Publication
(10) Pub. No.: US 2004/0129730 A1
(43) Pub. Date: Jul. 8, 2004

(54) Tactical defense aerosol device

(76) Inventor: Kevin L. Parsons, Appleton, WI (US)

Correspondence Address: Eric D. Cohen, Welsh & Katz, Ltd., 22nd Floor, 120 South Riverside Plaza, Chicago, IL, 60606, US

(21) Appl. No.: 10/625,388

(22) Filed: Jul. 23, 2003

Related U.S. Application Data
(60) Provisional application No. 60/398,717, filed on Jul. 26, 2002.

(51) Int. Cl. B67B 5/00

(52) U.S. Cl. 222/153.11

(57) ABSTRACT

A non-threatening spray dispenser that can be readily employed without requiring concentrated aiming and firing includes a connector coupling with mounted end cap that connects to an end of an irritant spray dispenser disposed in axial alignment with the end cap. The connector coupling supports a switch mechanism readily operable by the user's thumb while grasping the connector coupling to selectively dispense spray axially from the dispenser. The dispenser preferably utilizes the barrel and lens support end of a flashlight to facilitate use as a flashlight or for conversion to receive a pressurized chemical irritant cartridge, and enables selective interchangeability of nozzle plates of different color exposed surfaces to simulate a flashlight lens, provide a dark, non-reflective color during night maneuvers, or use a bright color so that a subject is readily aware that an irritant spray dispenser is pointed at him. The switch mechanism includes a safety button selectively operable to prevent unintended actuation of the dispenser.

### CROSS-REFERENCE TO RELATED APPLICATIONS

The present application claims priority from provisional application Serial No. 60/398,717, filed Jul. 26, 2002, entitled “Tactical Defense Device Having Baton and Fluid Dispensing Capabilities,” which is incorporated herein by reference in its entirety.

### BACKGROUND OF THE INVENTION

The present invention relates generally to defense devices as used by law enforcement and military personnel, and more particularly to a tactical defense device that can be used to dispense a spray, such as a chemical irritant.

It is a common practice for law enforcement and military personnel whose assignments place them in potentially confrontational situations to carry a chemical dispensing device operative to dispense a chemical irritant which, when discharged in the general direction of a person's face, at least temporarily impairs the person's sight and breathing so as to reduce the threat of harm to law enforcement personnel. Chemical irritant dispensers are well known. Such dispensers typically employ a large aerosol canister containing an aerosol pepper spray or other irritant, such as, for example, the MACE brand of chemical irritant spray manufactured by Mace Security International. When used by law enforcement personnel and individuals requiring on-the-job protection, such as postal service workers, delivery persons and the like, the dispensers generally are carried in holsters worn on a belt or uniform.

Typically, many known dispensers are held in a vertical position when deployed, much like a handheld aerosol paint dispenser. Such dispensers have the disadvantages that they are easily identifiable, and unless they are properly aimed, it is possible to inadvertently dispense the chemical spray on oneself. Because chemical irritant dispensers generally are activated under stressful conditions, the requirement for conscientious and accurate arming is a significant drawback. Moreover, the need for deliberate aiming and firing reduces or eliminates the element of surprise and permits an adversary to prepare for or avoid the spray. Recent advances to overcome such drawbacks include the provision of a chemical irritant dispenser that can be readily held in one's hand and actuated by the user's thumb to release or discharge the chemical irritant while holding the dispenser in a horizontal position while gripped in the user's hand. See, for example, U.S. Pat. No. 5,509,581, which discloses such a device.

It is also a common practice for law enforcement and military personnel to carry flashlights. Because of their universal use, flashlights do not appear threatening and have easy-to-recognize shapes. It thus follows that a defensive spray dispenser that appears in a non-threatening form, such as a flashlight with a secure gripping surface, and that facilitates accurate arming and ease of operation, would enhance the use and safety value for law enforcement and military personnel.

### SUMMARY OF THE INVENTION

One of the objects of the present invention is to provide a tactical defense device in the form of a spray dispenser that can be readily employed without requiring complex re-orientation of the device.

A more particular object of the invention is to provide a spray dispenser employing a connector coupling that can be connected by its outer end to an end cap, and by its inner end to an end of an irritant spray dispenser disposed in axial alignment with the cap, the connector coupling having a switch actuating mechanism readily operable by a user's thumb or finger while grasping the connector coupling in the user's hand to selectively dispense spray axially from the dispenser.

A feature of the present invention lies in the ability to use the spray dispenser as a non-lethal tactical defense device, which has the appearance of a flashlight so as not to appear outwardly threatening to a subject or adversary during use. Police officers using a flashlight or an ASP Tactical Baton are taught to hold the light with the lens of the light facing the subject and the barrel of the light extending backward over the officer's shoulder. From this non-threatening position, the officer can ward off blows or attacks.

Yet another feature of the spray dispenser in accordance with the invention lies in the interchangeability of nozzle plates at the dispensing end of the dispenser that enables use of different color exposed nozzle surfaces. For example, a shiny nozzle surface may be used to simulate a flashlight lens, thus concealing the fact that the user may be pointing an irritant dispenser at a subject. Alternately, a dark, non-reflective color may be used during a maneuver undertaken at night, or a bright color may be used to enable a subject to be readily aware that an irritant spray device is pointed at the subject.

Another feature of the present invention lies in the provision of a connector coupling, which is adapted for connection to the rear end of the irritant dispenser spray and that includes a switch mechanism operative to actuate a spray cartridge longitudinally in linear relation to generally radial actuation of a switch button relative to the axis of the coupling. The switch button is movable when the connector coupling is grasped by either hand of the user between a safety position preventing actuation of the spray dispenser and a release position enabling actuation of the spray dispenser.

Yet another feature of the spray dispenser in accordance with the invention lies in the ability to readily adapt a flashlight portion of a combination baton and flashlight, such as the device disclosed in U.S. Pat. No. 6,283,609 and incorporated herein by reference, to an irritant dispenser. Common components of the flashlight are utilized, thereby significantly reducing manufacturing costs.

Further objects, features and advantages of the present invention, together with the organization and manner of use thereof, will become apparent from the following description of the invention when taken in conjunction with the accompanying drawings wherein like reference numerals designate like elements throughout the several views.

While the present invention is susceptible to various modifications and alternative forms, specific embodiments thereof are shown by way of example in the accompanying drawings and will be described in detail. It should be understood that the drawings and detailed description thereof are not intended to limit the invention to the particular form disclosed, but rather the invention is intended to cover all modifications, equivalents and alternatives falling within the sprit and scope of the present invention.

### BRIEF DESCRIPTION OF THE DRAWINGS

FIG. 1 is a plan view of a spray dispenser in accordance with a preferred embodiment of the present invention, with an elevational sectional view of an end cap adapted to be mounted in the outer end of the connector coupling;

FIG. 2 is an elevational sectional view of the spray dispenser of FIG. 1 with the connector coupling removed;

FIG. 3 is an exploded plan view of the spray dispenser illustrated in FIG. 1 showing assembly of the tactical defense device;

FIG. 4 is an exploded view illustrating the components of the connector coupling for connecting the spray dispenser to an end cap;

FIG. 5 is an elevational view of a nozzle plate employed at the discharge end of the spray dispenser;

FIG. 6 is an edge view of the nozzle plate of FIG. 5;

FIG. 7 is an edge elevational view of an elastomeric seal for mounting on the periphery of the nozzle plate of FIGS. 5 and 6;

FIG. 8 is a side elevational view of an actuator plunger employed in a switch mechanism within the connector coupling;

FIG. 9 is an end elevational view of the actuator plunger of FIG. 8;

FIG. 10 is an end elevational view of the opposite end of the actuator plunger of FIG. 8;

FIG. 11 is a plan view of the actuator plunger of FIG. 8;

FIG. 12 is a plan view of the connector coupling housing employed in the spray dispenser of FIG. 1;

FIG. 13 is an axial sectional view of the housing of FIG. 12;

FIG. 14 is an elevational sectional view of the end cap adapted to be mounted in the outer end of the connector coupling;

FIG. 15 is an elevational view as viewed from the left-hand end of the connector coupling housing illustrated in FIG. 13;

FIG. 16 is an elevational view of the connector coupling housing of FIG. 13 as viewed from the right-hand end of FIG. 13;

FIG. 17 is a side view of an actuator button employed in the switch mechanism for the dispenser, with portions broken away for clarity;

FIG. 18 is a back view of the actuator button of FIG. 17;

FIG. 19 is a front view of the actuator button of FIG. 17;

FIG. 20 is a plan view of the actuator button of FIG. 17;

FIG. 21 is an elevational view of a safety slide button employed with the actuator button of FIG. 17; and

FIG. 22 is a bottom view of the safety button of FIG. 21.

### DETAILED DESCRIPTION

Referring now to the drawings, and in particular to FIGS. 1-3, a tactical defense device having spray dispensing capabilities in accordance with the present invention is indicated generally at 10. The tactical defense device 10 includes a spray dispensing portion 14, a connector coupling 16, and an end cap 15. The connector coupling 16 houses a switch mechanism 13 selectively operable to dispense an irritant from a dispenser cartridge 40 disposed in the spray dispensing portion 14, such as aerosol pepper spray or other irritant. The tactical defense device 10 is particularly useful by law enforcement and military personnel as a non-lethal tactical device to temporarily incapacitate or fend off an aggressive adversary or attacker, or otherwise assist in control of highly charged crowds through dispensing a spray irritant to cause temporary debilitation by inhibiting sight and causing significant irritation of breathing passages.

The end cap 15 of the tactical device 10 is of known construction, with an external male thread 17 formed thereon, and adapted to receive the connector coupling 16 in threaded connection thereon. Preferably, the spray dispenser portion 14 utilizes a cylindrical tubular flashlight body similar or identical to that disclosed in U.S. Pat. No. 6,283,609 so as to present the appearance of a flashlight, which may render the spray dispenser's appearance non-threatening. Conversion of a pre-existing cylindrical tubular flashlight body to a spray dispenser portion 14 by replacing the flashlight's reflector, switch housing, and batteries also may significantly reduce manufacturing costs.

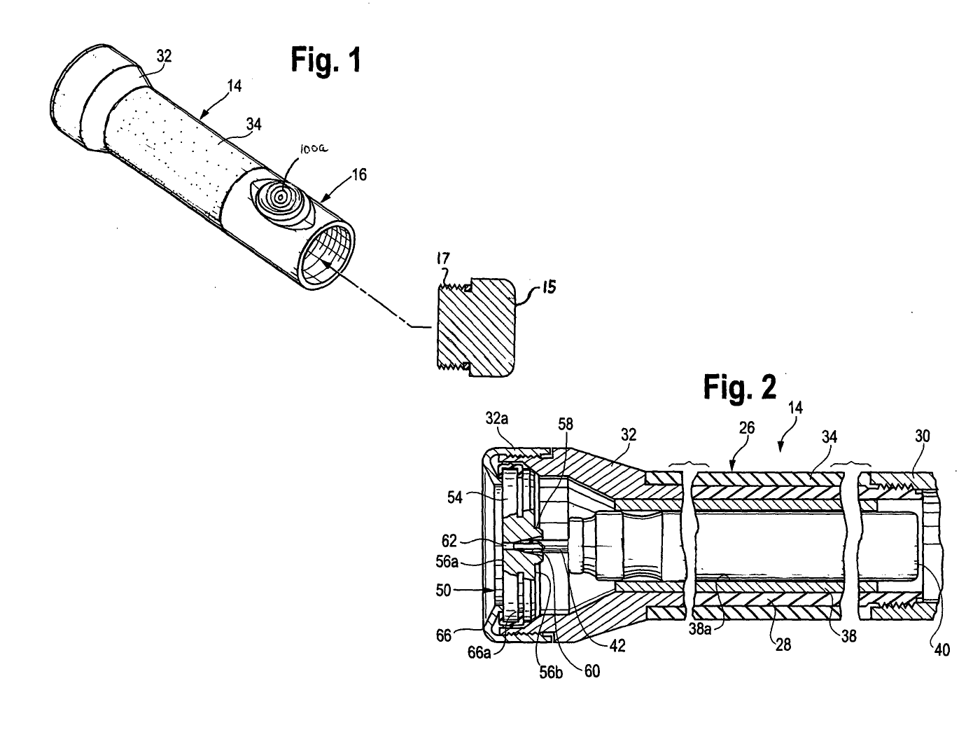

Referring particularly to FIGS. 1 and 2, the spray dispenser 14 has a generally tubular body 26 that includes a cylindrical tubular metallic portion 28 having an external male thread 30 formed on its rearward end. The cylindrical tubular portion 28 preferably terminates at its forward end in a generally outwardly diverging conical portion 32 having an external annular male thread 32a formed on its forward end. The cylindrical tubular portion 28 of the dispenser preferably has an annular cover sleeve 34 formed along its length, which may be molded or applied thereon, and which may be formed of a material suitable to enhance gripping of the spray dispenser 14. The cover sleeve 34 may also be bonded to the cylindrical tubular portion 28, as is known. The cover sleeve 34 provides a universal gripping surface preferably with 360 degree coverage about the circumference of the cylindrical tubular portion 28.

In the illustrated embodiment, the tubular body 26 may have an annular sleeve or tube 38 inserted within the cylindrical metallic portion 28. The sleeve 38 may be used if a non-standard size aerosol canister 38 is used. Preferably, the sleeve 38 is not needed when a standard size aerosol canister 38 is used. The sleeve 38 has an outer diameter that enables the sleeve to be slidingly inserted within the cylindrical body 28, and has an internal cylindrical bore 38a sized to receive the cylindrical aerosol canister 40. The sleeve 38 may be sized with respect to its internal diameter to permit aerosol canisters 40 of different diameters to be received. Preferably a canister of standard size may be approximately 3-5 inches in length and one-half inch in diameter. The sleeve 38 preferably is made of a non-corrosive material, such as a suitable plastic, that is unaffected by the irritant or other substance contained within the aerosol canister or container 40. The canister 40 has a length such that a forward end terminates at the mouth of the diverging conical portion 32 of the cylindrical portion 28, and terminates at a rearward end 41 short of the rearmost end 29 of the cylindrical portion 28, as shown in FIG. 2. The outward divergence of the conical portion 32 protects the user from exposure to the irritant contained within the canister 40, and prevents the device 10 from sliding out of the user's hand.

The aerosol canister 40 may be of the type disclosed in U.S. Pat. No. 5,509,581, which is incorporated herein by reference in its entirety. The aerosol canister has a tubular discharge nozzle 42 at its forward end operative to release the pressurized contents of the canister 40 when the discharge nozzle 42 is depressed axially inwardly of the canister.

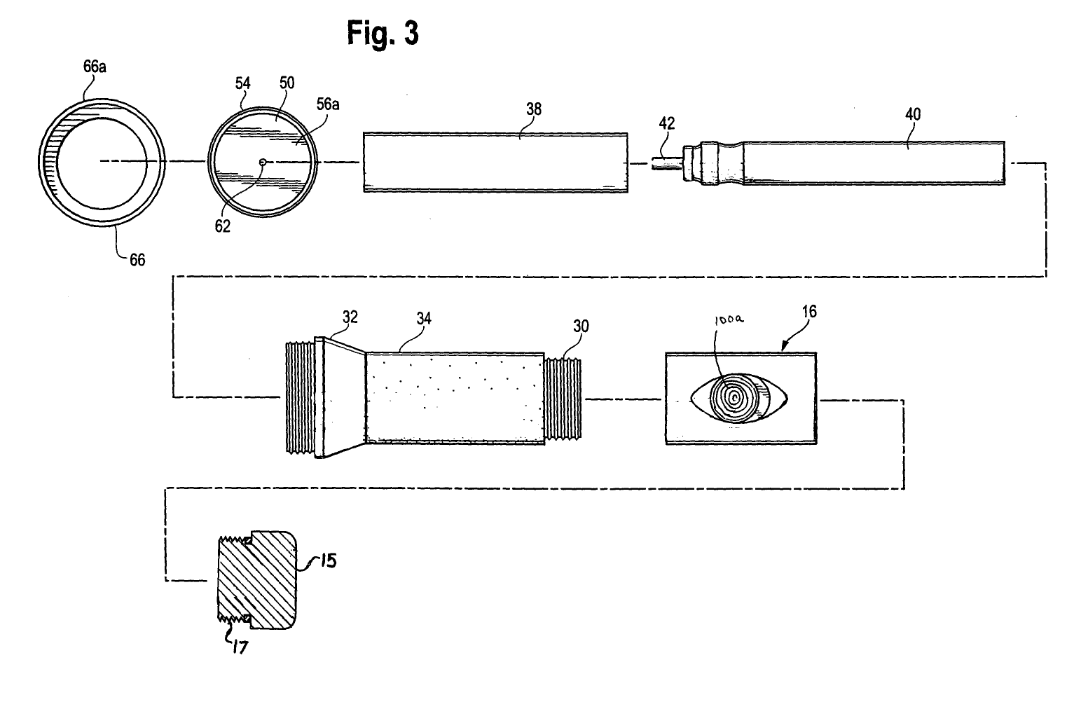

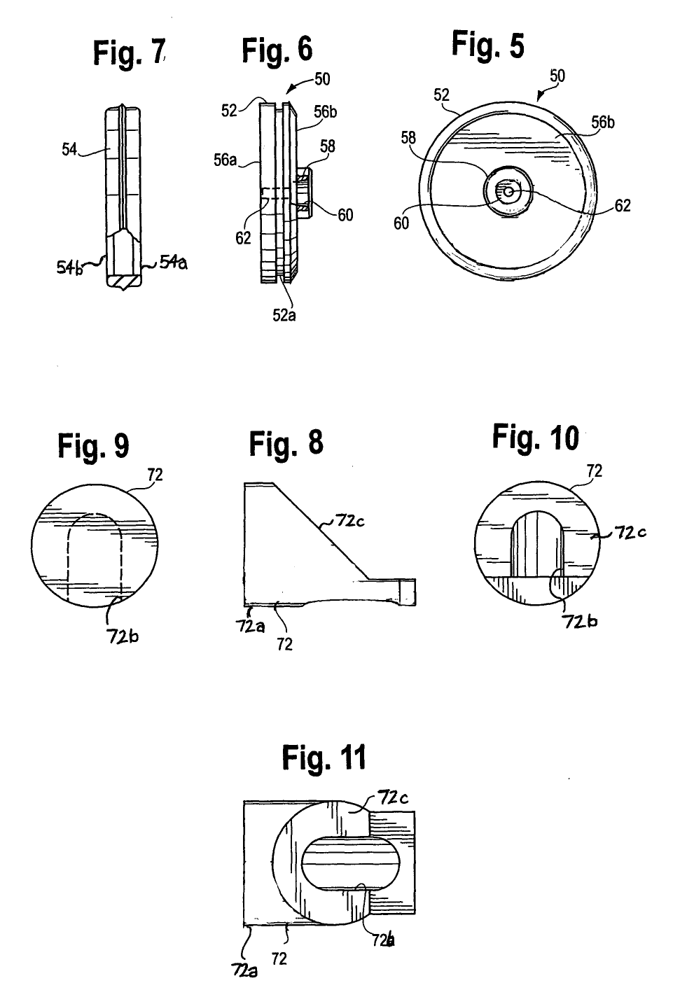

In the illustrated embodiment, the forward end 31 of the conical portion 32 of the tubular body 26 is adapted to support a circular nozzle plate 50 (see FIGS. 2, 5 and 6). The nozzle plate 50 preferably is made of a non-corrosive material, such as aluminum, and has an outer annular surface 52 in which is formed an annular groove 52a. An annular resilient seal member 54, illustrated in FIG. 7, is configured to cooperate with the annular surface 52 of the nozzle plate 50, and has inwardly directed peripheral edges 54a and 54b which seat within the groove 52a and extend about the outer peripheral edge of the face of the nozzle plate 50, respectively, so as to be retained on the nozzle plate 50, as shown in FIG. 3.

The nozzle plate 50 has opposite parallel planar surfaces 56a and 56b, respectively referred to as the outer planar exposed surface and the inner planar surface of the nozzle plate 50. A generally cylindrical boss 58 is formed on the inner planar surface 56b so as to extend coaxially rearwardly from the inner planar surface, as illustrated in FIG. 6. The cylindrical boss 58 has a countersunk orifice 60 partially formed through the thickness of the boss 58. A smaller diameter discharge orifice 62 extends coaxially through the thickness of the boss 58 and through to the outer exposed surface 56.

Referring again to FIG. 2, the nozzle plate 50 and associated external seal member 54 are sized so as to be snugly received within an annular surface formed within the forward end portion 32 of the dispenser body 26. Thus, the discharge orifice 62 and associated countersunk orifice 60 are coaxial with the longitudinal axis of the cylindrical tubular portion 28. The nozzle plate 50 is retained within the forward end of the dispenser body 26 by an annular retainer 66 having an internal thread 66a adapted for threaded cooperation with the external thread 32a on the forward end of the conical body portion 32.

One preferable feature of the present invention lies in the provision of a plurality of nozzle plates 50 having different color outer exposed surfaces 56a. For example, forming a silver-colored coating over the outer exposed surface 56a simulates a flashlight lens so that in a lighted environment, law enforcement personnel could aim the spray dispenser 14 toward a subject, who may consider the reflective surface of the nozzle plate 50 to be a flashlight lens, and thus may be less apt to flee to evade a discharged spray of irritant. An alternative nozzle plate 50 may be provided having a generally dark or black non-reflective surface 56a so that when the spray dispenser 14 is aimed at a subject in a darkened environment, the subject cannot detect whether the irritant spray dispenser is an actual spray dispenser or whether it is a flashlight, thus again enabling the officer to approach the subject and obtain a shorter spray distance in the event it is necessary to discharge irritant from the dispenser. A still further embodiment is to provide a nozzle plate 50 having a bright, highly visible color on the exposed surface 56a, such as a red color, so that a subject readily may detect that the dispenser 14 is not a flashlight, thus becoming less active when confronted by the officer, knowing that he could be subjected to a debilitating irritant spray.

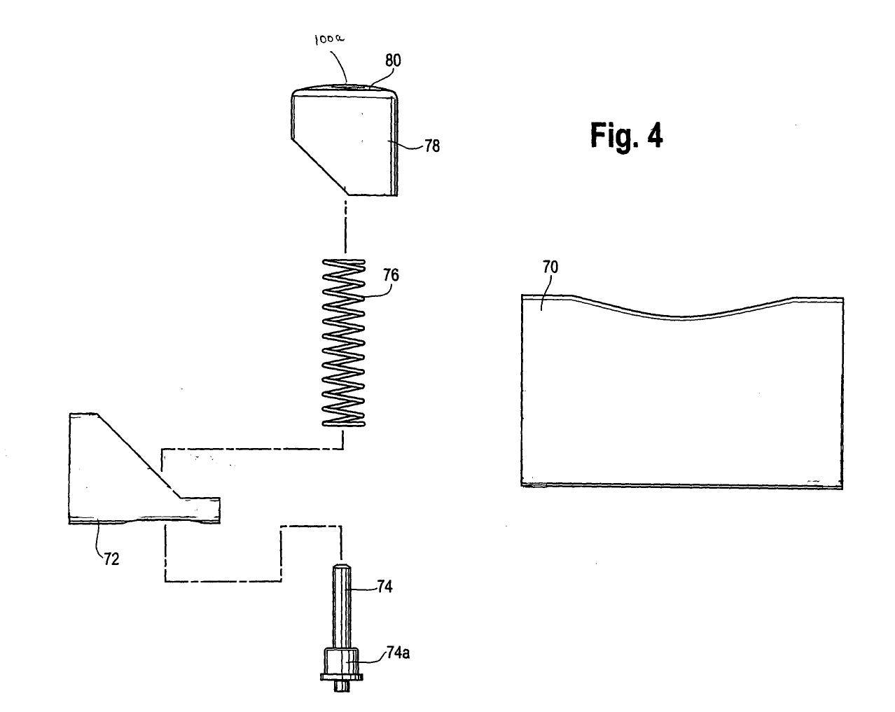

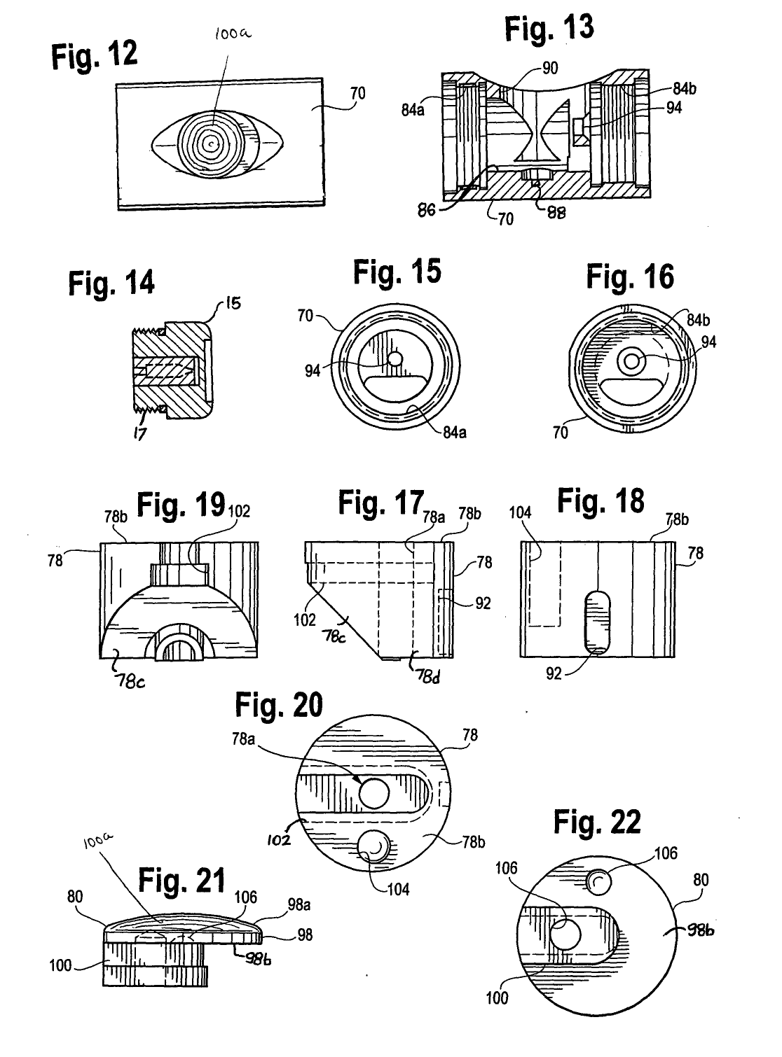

Referring now to FIG. 4, taken in conjunction with FIGS. 8-22, the connector coupling 16 includes a generally hollow cylindrical plunger housing 70 configured to receive a plunger actuator 72 (shown in greater detail in FIGS. 8-11), a guide pin 74, a coil compression spring 76, and an actuator button 78 that carries a safety slide button 80.

As illustrated in FIGS. 13, 15, and 16, the cylindrical plunger housing 70 of the connector coupling 16 has internal female threads 84a and 84b formed on opposite ends, which are adapted to receive and mate with the external threaded end 30 (FIG. 3) of the tubular body 26 (FIG. 2) and the external thread 17 (FIGS. 1, 3) formed on the end cap 15 (FIGS. 1, 3), respectively. The plunger housing 70 has a cylindrical bore 86 adapted to slidingly receive a cylindrical outer surface portion 72a (FIG. 8) of the plunger actuator 72 (FIG. 8) so as to enable axial movement of the plunger actuator. As shown in FIGS. 11 and 13, the plunger actuator 72 has an elongated opening 72b extending transverse to its longitudinal axis that receives an enlarged diameter portion 74a of the guide pin 74 that is inserted into the plunger housing 70 so that a lower flange end of the guide pin 74 is received within a recess 88 formed within the plunger housing 70.

When the plunger actuator 72 is mounted within the plunger housing 70 with the guide pin 74 extending upwardly through the elongated opening 72b, an actuator button 78 may be inserted downwardly over the guide pin 74 so that the guide pin 74 extends through a cylindrical bore in the actuator button 78. The plunger housing 70 has a cylindrical bore 90 transverse to its other bore axis 86 to slidably receive an outer cylindrical surface on the actuator button 78, and thereby guide the actuator button 78 as it is moved vertically on the guide pin 74. The plunger actuator 72 and actuator button 78 have mutually cooperating beveled surfaces 72c and 78c, respectively, that sliding engage with each other so that depressing the actuator button 78 against the upward bias of the spring 76 effects axial movement of the plunger actuator 72 along the center axis of the plunger housing 70 so as to engage and push the canister 40 forward within the cylindrical tubular portion 28. As the tubular discharge nozzle 42 of the canister 40 contacts the nozzle plate 50, the tubular discharge nozzle partially retracts, emitting the chemical irritant through the discharge orifice 62.

Referring now to FIGS. 13, 15, 16, and 18, movement of the actuator button 78 is limited in its outward position relative to the plunger housing 70, and thereby also relative to the plunger actuator 72, by a suitable stop screw (not shown) that is threaded into a threaded bore 92 formed in the plunger housing 70. The inner end of the screw is sized and configured to enter a longitudinal slot or groove 94 formed in the outer surface of the actuator button 78, as best seen in FIG. 18. The upper end of the slot 94 is established to enable downward depressing of the actuator button 78 sufficient to effect the desired axial movement of the plunger actuator 72. The lower end of the slot 94 is established to engage the inner end of the stop screw when the actuator button 78 has disengaged from the plunger actuator 72. The compression spring 76 is disposed coaxially on the guide pin 74 and extends into an annular groove 78d in the actuator button 78 to bias the actuator button 78 to its outward position relative to the plunger housing 70.

Referring now to FIGS. 2 and 19-22, a feature of the actuating mechanism for the irritant spray canister 40 is the safety slide button 80 which cooperates with the actuator button 78 to enable a natural depressing of the actuator button for selectively dispensing spray irritant from the canister 40. The safety slide button 80 may be moved to a safety position preventing depression of the actuator button 78. The safety slide button 80 has a circular cap portion 98 of a diameter equal to the diameter of the upper end of the actuator button 78. The cap portion 98 has an upper convex or crowned surface 98a and a bottom planar surface 98b on which is formed a depending retainer leg 100. The retainer leg 100 allows the cap portion 98 to slide longitudinally to the connecter coupling 16 but prevents rotational movement. The upper convex surface 98a of the cap portion 98 preferably has raised concentric rings 100a formed on its surface to facilitate tactile feedback and control with respect to the user's thumb grip on the safety slide button 80. The concentric rings 100a are preferably raised or “step-like” in contour to facilitate the user's grip on the safety slide button. The rings 100a facilitate a positive and slip-proof grip.

The retainer leg 100 has a generally inverted “T” shape in transverse cross section, and is adapted to be slidingly received in a similarly shaped slot 102 formed in the actuator button 78 so as to intersect an upper surface 78b. The retainer leg 100 and slot 102 are sized to enable sliding movement of the safety slide button 80 between a first position and a second position. In the first position, the cap portion 98 is coaxial with the actuator button 78 to permit discharge of irritant spray from the dispenser 14. In the second position, the cap portion 98 is offset from its coaxial position so as to overlie and engage a surface on the plunger housing 70 in a manner to prevent depressing or actuation of the actuator button 78, thus preventing inadvertent discharge of irritant spray from the dispenser 14. However, should the tactical defense device 10 be seized by an adversary from a user while the safety button 80 is at an “armed,” rather than a “safe” setting, the adversary may spray himself with irritant during the struggle, as the discharge orifice 62 of the nozzle plate 50 would be pointed in his direction.

Preferably, at least one channel is provided between the upper surface 78b of the actuator button 78 and the lower planar surface of the safety slide button 80. The channel cooperates with an opposed recess so as to releasably retain the safety slide button 80 in its non-locking position coaxial with the actuator button 78. The channel also enables sliding movement of the safety slide button 80 along the axis of the T-shaped slot 102 to its safety lock position, preventing depression of the actuator button 78. To this end, a cylindrical bore 104 is formed in the actuator button 78 so as to intersect the upper surface 78b of the actuator button 78. The cylindrical bore 104 is configured to include a channel (not shown) that is mutually cooperable with a semi-spherical recess 106 formed in the lower surface 98b of the cap portion 98 of the safety slide button 80.

When assembled, the plunger actuator 72, guide pin 74, coil spring 76, actuator button 78, and associated safety slide button 80 are mounted within the plunger housing 70 of the connector coupling 16. Accordingly, the threaded ends 84a and 84b of the plunger housing 70 are connected via the threads to the dispenser body 26 and end cap 15, respectively. As such, depression of the actuator button 78 when the safety slide button 80 is in a position enabling depression causes the plunger actuator 72 to move axially relative to the plunger housing 70 and engage the rear end of the irritant canister 40. This forces the discharge nozzle 42 into the passage 60 while the discharge nozzle 42 is forced into the body of the canister 40, causing pressurized irritant within the canister 40 to be discharged through the orifice 62. When the safety slide button 80 is moved to a position offset from its axially aligned position with the actuator button 78 (a “safety” position), depression of the actuator button, and thus discharge of irritant from the canister 40 is prevented. By default, the safety button 80 of the tactical defense device 10 is set to a safety position. The user easily is able to determine whether the safety slide button 80 is in a “safe” setting or in an “armed” setting both visually and tactilely. Advantageously, the tactical defense device 10 is designed to be effortlessly operable by both right- and left-handed users.

While a preferred embodiment of the present invention has been illustrated and described, it will be understood to those skilled in the art that changes and modifications may be made therein without departing from the invention in its broader aspects.

What is claimed is:

1. A tactical defense device, comprising:
a dispenser having a tubular body having a first end defining a forward portion and an opposite second end, the tubular body adapted to receive a pressurized spray cartridge;
a nozzle plate having a discharge orifice supported within the forward portion; and
a tubular connector coupling having a first end adapted for connection to the second end of the dispenser and an opposite second end, the connector coupling housing a switch mechanism.

2. The device in accordance with claim 1 wherein the forward portion of the dispenser is enlarged.

3. The device in accordance with claim 1 wherein the first and second ends of the dispenser define annular threads.

4. The device in accordance with claim 1 including an annular retainer adapted for connection to the first end of the dispenser.

5. The device in accordance with claim 4 wherein the annular retainer includes an interior thread.

6. The device in accordance with claim 1 wherein the dispenser includes a slidingly insertable sleeve for holding a pressurized spray cartridge.

7. The device in accordance with claim 1 wherein the dispenser has an annular cover sleeve formed thereon.

8. The device in accordance with claim 7 wherein the annular cover sleeve is formed of a material suitable to enhance gripping of the dispenser, such as foam.

9. The device in accordance with claim 1 wherein the discharge orifice of the nozzle plate is in axial alignment with a discharge nozzle of an inserted pressurized spray cartridge.

10. The device in accordance with claim 1 wherein an outer planar exposed surface of the nozzle plate is made of a light-reflective material.

11. The device in accordance with claim 10 wherein the outer planar exposed surface of the nozzle plate is a silver color.

12. The device in accordance with claim 1 wherein the outer planar exposed surface of the nozzle plate is made of a non-reflective material.

13. The device in accordance with claim 12 wherein the outer planar exposed surface of the nozzle plate is a dark, buff color.

14. The device in accordance with claim 1 wherein the outer planar exposed surface of the nozzle plate is made of a brightly colored material.

15. The device in accordance with claim 14 wherein the outer planar exposed surface of the nozzle plate is a red color.

16. The device in accordance with claim 1 including a plurality of interchangeable nozzle plates having different outer planar exposed surfaces.

17. The device in accordance with claim 1 wherein an external seal member is associated with the nozzle plate.

18. The device in accordance with claim 1 including an end cap adapted for connection to the second end of the connector coupling.

19. The device in accordance with claim 18 wherein the end cap and the dispenser are in substantially axial alignment.

20. The device in accordance with claim 18 wherein the end cap defines an external thread.

21. The device in accordance with claim 1 wherein the switch mechanism includes a plunger actuator and an actuator button that carries a safety slide button.

22. The device in accordance with claim 21 wherein the switch mechanism further includes a guide pin and a coil compression spring.

23. The device in accordance with claim 21 wherein the safety slide button includes a circular cap portion with a retainer leg formed thereon.

24. The device in accordance with claim 23 wherein the cap portion of the safety slide button is formed with concentric rings on its surface.

25. The device in accordance with claim 23 wherein the actuator button and the cap portion of the safety slide button have mutually cooperable channels.

26. A tactical defense device, comprising:
a dispenser having a tubular body having a first end defining a forward portion and an opposite second end, the dispenser adapted to receive a pressurized spray cartridge;
a nozzle plate having a discharge orifice supported within the forward position;
a tubular connector coupling having a first end adapted for connection to the second end of the dispenser and an opposite second end, the connector coupling housing a switch mechanism; and
a switch mechanism having a plunger actuator, a guide pin, a coil compression spring, and an actuator button carrying a safety slide button.

27. The device in accordance with claim 26 wherein the forward portion of the dispenser is enlarged.

28. The device in accordance with claim 26 wherein the first and second ends of the dispenser define annular threads.

29. The device in accordance with claim 26 including an annular retainer adapted for connection to the first end of the dispenser.

30. The device in accordance with claim 29 wherein the annular retainer includes an interior thread.

31. The device in accordance with claim 26 wherein the dispenser includes a slidingly insertable sleeve for holding a pressurized spray cartridge.

32. The device in accordance with claim 26 wherein the dispenser has an annular cover sleeve formed thereon.

33. The device in accordance with claim 32 wherein the annular cover sleeve is formed of a material suitable to enhance gripping of the dispenser, such as foam.

34. The device in accordance with claim 26 wherein the discharge orifice of the nozzle plate is in axial alignment with a discharge nozzle of an inserted pressurized spray cartridge.

35. The device in accordance with claim 26 wherein an outer planar exposed surface of the nozzle plate is made of a light-reflective material.

36. The device in accordance with claim 35 wherein the outer planar exposed surface of the nozzle plate is a silver color.

37. The device in accordance with claim 26 wherein the outer planar exposed surface of the nozzle plate is made of a non-reflective material.

38. The device in accordance with claim 37 wherein the outer planar exposed surface of the nozzle plate is a dark, buff color.

39. The device in accordance with claim 26 wherein the outer planar exposed surface of the nozzle plate is made of a brightly colored material.

40. The device in accordance with claim 39 wherein the outer planar exposed surface of the nozzle plate is a red color.

41. The device in accordance with claim 26 including a plurality of interchangeable nozzle plates having different outer planar exposed surfaces.

42. The device in accordance with claim 26 wherein an external seal member is associated with the nozzle plate.

43. The device in accordance with claim 26 including an end cap adapted for connection to the second end of the connector coupling.

44. The device in accordance with claim 43 wherein the end cap and the dispenser are in substantially axial alignment.

45. The device in accordance with claim 43 wherein the end cap defines an external thread.

46. A dispenser device comprising, in combination,
a dispenser including a tubular body having a first end and an opposite second end defining a head portion, the tubular body adapted to receive a pressurized spray cartridge having a discharge nozzle configured to be disposed adjacent the head portion;
a nozzle plate supported within the head portion and having a discharge orifice in axial alignment with the discharge nozzle and adapted for cooperation with the discharge nozzle to effect discharge from the cartridge when disposed in predetermined relation to the discharge orifice;
a tubular connector coupling having a first end adapted for connection to an end cap, and a second end adapted for connection to the first end of the dispenser, the end cap and dispenser body being in substantially axial alignment;
the connector coupling having a switch mechanism supported therein including a switch actuator mutually cooperable with the spray cartridge; and
the connector coupling adapted to be actuated by a user's thumb or finger while grasping the connector coupling in the user's hand so as to effect discharge from the cartridge.

47. The device in accordance with claim 21 wherein the safety slide button is moved axially from a safety position to an armed position and is then depressed downwardly to activate the spray cartridge.

48. The device in accordance with claim 26 wherein the safety slide button is moved axially from a safety position to an armed position and is then depressed downwardly to activate the spray cartridge.

49. The device in accordance with claim 24 wherein the concentric rings are raised and have a step-like contour to facilitate a positive gripping action by a user.
